(19) United States
(12) Patent Application Publication
(10) Pub. No.: US 2005/0115728 A1
(43) Pub. Date: Jun. 2, 2005

(54) Method and device arrangement for improving the sound quality of an audio system

(76) Inventors: Pekka Saastamoinen, Kuusamo (FI); Markku Tyynismaa, Oulu (FI)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/495,696

(22) PCT Filed: Nov. 13, 2002
(86) PCT No.: PCT/FI02/00897

(30) Foreign Application Priority Data
Nov. 15, 2001 (FI) 20012217
Jan. 14, 2002 (FI) 20020064

(51) Int. Cl. H01B 7/00

(52) U.S. Cl. 174/27

(57) ABSTRACT

The present invention is related to method and device arrangement for improving the sound quality of an audio system. In a method and device arrangement according to the present invention, an electric current that transmits an audio signal is used to create a strong magnetic field in a component situated in the part of a signal conductor located between an amplifier and a speaker, which magnetic field improves the quality of audible sound.

The present invention relates to a method for improving the quality of an audible audio signal, in which method said audio signal is transmitted by means of electron movement in a metal conductor. The present invention also relates to a device arrangement for improving the sound reproduction of an audio signal, which device arrangement comprises an audio amplifier, an audio cable and a speaker element.

Audio systems have improved considerably primarily due to development work related to discrete components used in said audio systems. Amplifier devices and speakers of audio systems are designed to minimize interference and various types of distortion that said devices introduce into an audible signal. By these means advancements have been made in improving sound quality.

Nevertheless, sound reproduction still suffers from a certain inaccuracy in signal reproduction. All the components of an audio signal are not transmitted or reproduced at exactly the correct time compared with the original situation.

Amplifier devices cause various types of distortion and noise in a reproduced signal, and signal quantization in digital systems causes noise. Audio signal components may be reproduced at the correct time on average, but a certain amount of variation and interference is continuously present.

The present invention is related to sound reproduction technology's high-end range of sound reproduction, where the intent is to achieve extremely natural and original-sounding sound reproduction. It is known in this field that such factors, which cannot be fully explained or measured using current knowledge and measurement technology, have been observed to have an impact on the naturalness and accuracy of sound reproduction. Ordinary measurements, such as frequency response or distortion measurements, do not explain all the differences in sound reproduction found in different sound reproduction equipment. For example, it is possible to detect audible differences between the sound reproduction of equipment or assemblies even though they have been determined to be completely similar and to have faultless measured values when measured using traditional measurement technologies. It is known, for example, that Fourier analysis techniques commonly used in measurements are poorly suited for analyzing complex signals, especially in the case of essentially short-duration signals, which appear in music, for example.

In evaluating high-end equipment, the human ear and hearing are often relied on to assess the naturalness and quality of sound. Thus, we deem that we do not yet know how to measure or take into consideration all the physical phenomena affecting sound reproduction. In general, for example, factors related to and affecting the phases of a sound signal are considered to have an impact on the quality of an audible sound signal. One area where attempts are made to minimize the distorting effects of these factors on a reproduced audio signal is the intermediate wires between an audio amplifier and speakers, which are used to connect principal amplifier devices to speaker devices that produce audible sound. Very different types of functional designs have been employed to improve the influence on sound quality of said partial component.

One traditional means of attempting to improve the sound reproduction characteristics of a speaker is to increase the cross-section of the conductors used. The resistance of the conductor thereby decreases accordingly as its cross-section increases. One such solution is presented in international patent application WO 0077795. In the solution presented therein, the cross-section of a so-called return conductor is larger by a certain proportion than an actual signal conductor. Using large conductors with special cross-sections increases the manufacturing cost of the described cables.

Increasing the cross-section of a conductor also decreases the so-called skin effect. This refers to a crowding of electric current into the outer layer of a conductor as the frequency of a transmitted signal rises. Naturally, said skin effect increases the resistance of the conductor. When electric current squeezes into the surface layer of a conductor, another undesirable phenomenon results. Mechanical or chemical stress damages the crystal structure of the surface layer of a conductor over time. Areas in which the surface layer is in effect broken are formed on the surface of the conductor. Consequently, the resistance formed by the surface layer of the conductor grows even more, which is detectable as a deterioration of the sound quality of a sound reproduction system, especially when transmitting weak signals. To eliminate this phenomenon, a solution is presented in reference publication EP 0306067 B1, in which the metal of a conductor is replaced with a large amount of specially treated insulated carbon fibers, which are twisted together into one conductor. This prevents formation of the skin effect and above-mentioned mechanical and chemical fractures. A conductor manufactured in this manner is, however, very expensive compared with conventional conductor arrangements that utilize metals. Furthermore, such conductors are only supplied in precut form.

One manner of examining a speaker cable is to interpret it as a transmission wire, which has specific impedance. The structure of the cable determines the impedance level of the cable. Patent application UK 2323206 presents generally that at audio frequencies it is preferable to use a coaxial cable structure having small impedance. Patent publication U.S. Pat. No. 5,393,933 presents a ribbon-type cable with a geometric structure and materials resulting in very small impedance at audio frequencies. The above-mentioned cable structures are used to manufacture a cable whose impedance at audio frequencies is close to the impedance of speaker elements. Impedance matching is used to minimize undesired reflection phenomena at the junction between impedances. However, these solutions require special cables, which are expensive to manufacture.

The characteristics of cables used at audio frequencies can also be examined by means of the reactive components they contain. The capacitance and inductance values of an audio cable are determined on the basis of cable geometry and materials used. The resistance, conductance, capacitance and inductance of a cable determine the phase coefficient β of a transmission wire. At low frequencies, if the inductance value is small, β depends primarily on resistance and capacitance. The phase coefficient determines the phase velocity, which at low frequencies is approximately
vₚω/β=\sqrt{4πf/RC} (1)

The phase velocity vₚ depends on the frequency (f), for which reason the various 25 components of a transmitted signal advance at different velocities in a cable, thereby causing audible deterioration of signal quality.

One possibility of changing this frequency behavior of a cable at audio frequencies is to increase its inductance considerably by some means or other. Patent publication U.S. Pat. No. 4,920,233 presents a coaxial cable whose inductance is increased by covering the cable's insulation with magnetic material, such as ferrite, whereupon the inductance of the cable increases so much that the phase velocity of a signal is primarily determined by the cable's inductance and capacitance at audio frequencies, also.
vₚ=ω/β=1/\sqrt{LC} (2)

By this means the phase velocity is nearly constant, and the transmitted signal is not distorted.

In patent publication U.S. Pat. No. 4,843,356 the inductance of a coaxial cable is increased by placing small magnetic particles in the insulation.

The transmission characteristics of an audio cable can also be corrected by means of electronic devices connected to the audio cable. EP patent 0649268 presents an arrangement in which separate adjusting means are connected to both ends of an audio cable. A speaker cable is implemented by means of Litz conductors, which are comprised of a sufficient number of very thin individually insulated conductors connected in parallel to achieve a specific conductor cross-section. Litz conductors strive to diminish the skin effect and magnetic coupling between conductors. In the presented solution the adjusting means at the speaker end strives to prevent oscillation of the amplifier-speaker circuit at a relatively high resonance frequency in the magnitude of a few MHz. The adjusting means at the audio amplifier end adjusts the rate of current rise λ of the cable's conductors to a desired rate. The following correlation is in effect for the rate of current rise
λ=L/R (3)

According to the publication, to achieve optimal sound quality the value of λ should be 0-30 μs. According to the publication, the adjustable L and R values of the components connected in series with the cable's conductors are in the magnitude of 0.1-1 μH and 0-0.2 Ω, whereupon the optimal value for the rate of current rise λ is achieved. Due to the Litz conductor used, the manufacturing cost of the presented solution is high. Furthermore, the adjusting means include other discrete components, which further increase the production cost of the arrangement.

An electric signal in an ordinary metal conductor is transmitted by means of free electrons moving in the metal. A moving charge, such as an electron, always forms a magnetic field around itself. An electrical conductor and the material surrounding it influence how easily or difficultly said magnetic field is formed. Diamagnetic materials, such as copper, resist formation of a magnetic field, while ferromagnetic materials, such as iron in general, strengthen an external magnetic field introduced in them. Therefore, a varying electric current traveling in a copper conductor creates a magnetic field around itself, thereby causing a current and voltage phase difference of a certain magnitude in the conductor, which can be assumed to contribute to a change in the time relationships of the components of a transmitted audio signal.

In a solution presented in patent publication U.S. Pat. No. 5,109,140 an insulated ferromagnetic layer is placed around both conductors of an audio cable. The purpose is to sum and isolate the magnetic fields created in the conductors so that a magnetic field is not created outside the ferromagnetic layer and the energy of the audio signal is not consumed in creating said external magnetic field. The solution is supposed to minimize distortion in the signal caused by a magnetic field. Publication WO 9704467 also presents an audio cable having ferrite around an actual conductor to protect the conductor from electromagnetic disturbances.

Publication U.S. Pat. No. 4,885,555 presents a separate device arrangement that is connected to an audio cable, in which arrangement a cable is surrounded by a structure of ferromagnetic material, such as a toroid. The purpose of this structure is to improve the electrical characteristics of the cable and to force undesired “reflections” formed in the cable into a secondary circuit of the structure.

The purpose of the present invention is to describe a new type of device arrangement, which is suitable for use in conjunction with existing ordinary audio cables and which is simple and inexpensive to manufacture compared with solutions of the prior art.

A method for improving the quality of an audible audio signal according to the present invention is characterized by what is presented in inventive claim 1.

The objectives of the present invention are achieved using a device arrangement according to claim 2.

A device arrangement according to the present invention is characterized by what is presented in inventive claim 2.

Certain preferred embodiments of the present invention are presented in the dependent claims.

The basic principle of the present invention is as follows: An audio signal moving in a conductor is conducted into a magnetic field, which has been observed to have an advantageous effect on sound quality. Said magnetic field is formed by means of an electric current, created by a signal traveling in a conductor, by conducting said signal through either a coil or an intermediate component made of ferromagnetic material, such as iron, whereupon a strong, uniform magnetic field is formed. In said magnetic field, a phenomenon takes place, which advantageously affects distortions in the audio signal, diminishing them. The same phenomenon has been observed to happen when the ferromagnetic intermediate component is heated by means of external energy. The device arrangement has been tested using numerous listening tests, which support this estimation. Results and impressions attained from tests coincide very closely with what has been achieved using prior special arrangements, such as cable structures, described in many international publications.

Because it has been experimentally observed that a device arrangement according to the present invention has an advantageous effect on an audio signal only when ferromagnetic metals, such as iron, or a coil is used in various embodiments of the present invention, there is good reason to assume that the impact on the quality of an audio signal is based on a magnetic field, which in a device arrangement according to the present invention is created in a ferromagnetic metal or coil as a result of an electric signal traveling therein. The resulting magnetic field further advantageously affects the flow of the signal traveling in the metal. A similar phenomenon is most likely utilized in the above-mentioned publications that skirt the art of the present invention.

An advantage of the present invention is that it can be used to improve the quality of an audible audio signal, such as the breadth of sound, reproduction of rhythm, reproduction of soloists and resolution.

Another advantage of the present invention is that it can be implemented as part of an existing audio system.

Yet another advantage of the present invention is that its implementation does not require expensive audio cables or separate electronic devices.

The present invention is described in detail below, with reference to the enclosed drawings.

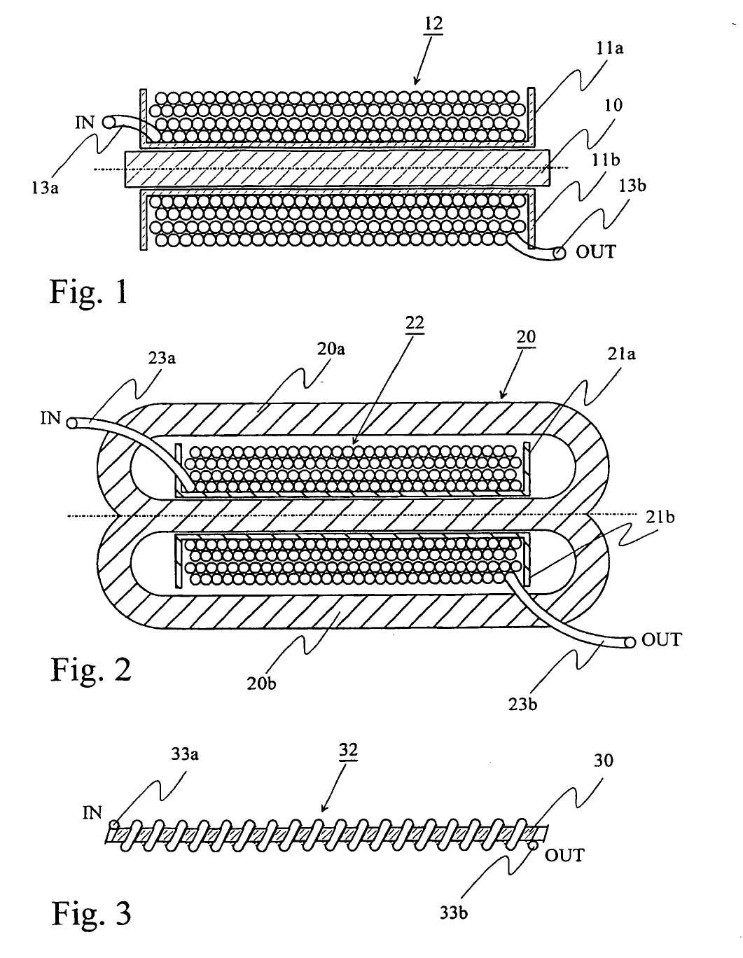

FIG. 1 presents a preferred embodiment of the present invention,

FIG. 2 presents a second preferred embodiment of the present invention,

FIG. 3 presents a third preferred embodiment of the present invention,

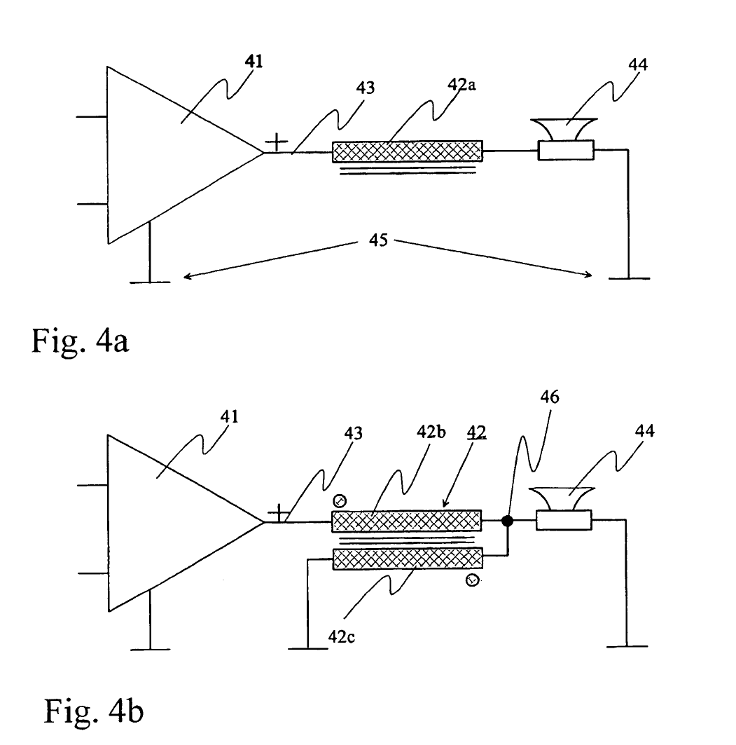

FIG. 4a presents an exemplary connection of a device according to the present invention to an audio system and

FIG. 4b presents a second exemplary connection of a device according to the present invention to an audio system.

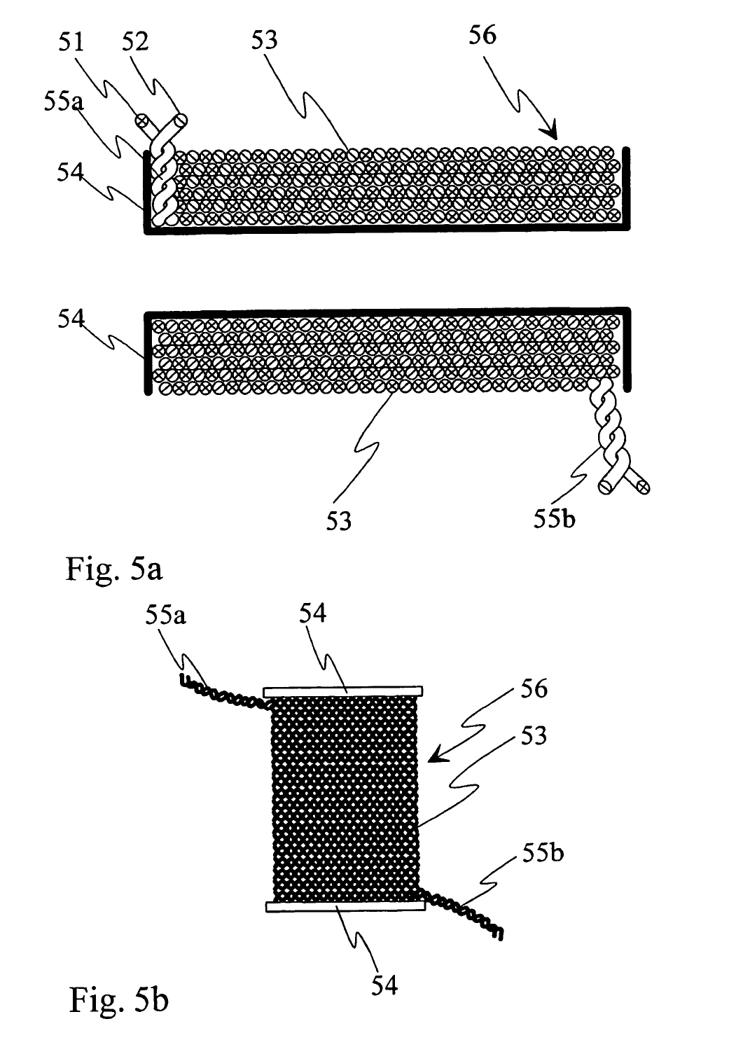

FIG. 5a presents a cross-section of a fourth preferred embodiment of the present invention,

FIG. 5b presents a side view of the same fourth preferred embodiment of the present invention,

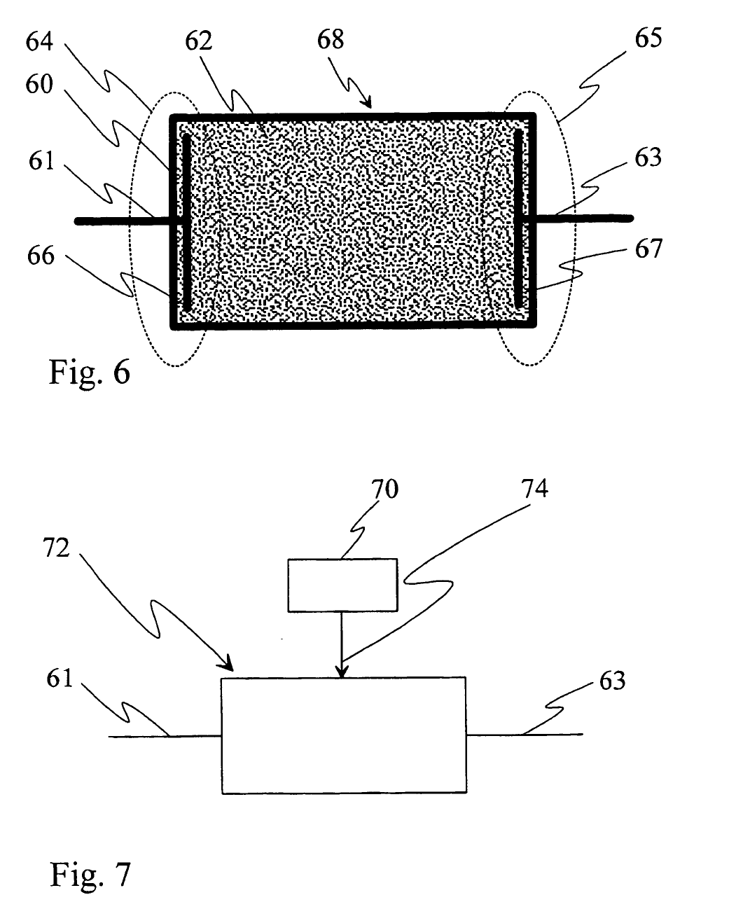

FIG. 6 presents a fifth preferred embodiment of the present invention,

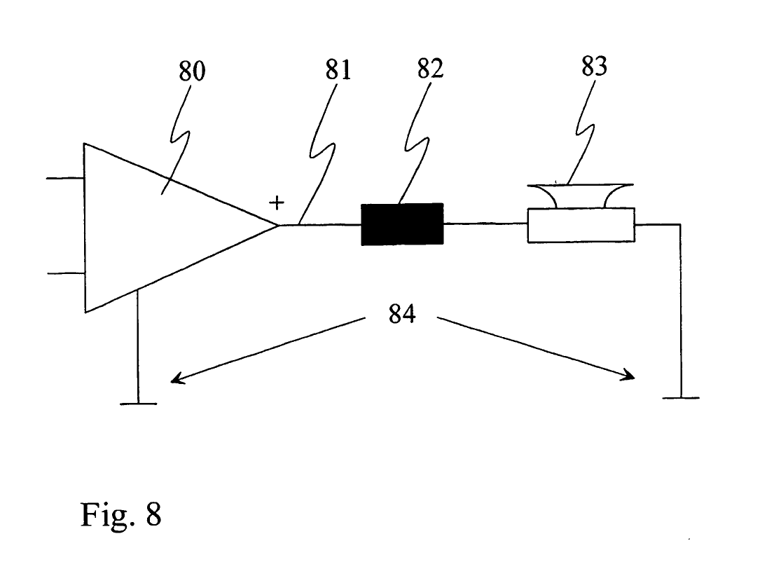

FIG. 7 presents a sixth preferred embodiment of the present invention and

FIG. 8 presents an exemplary connection of a device according to the present invention to an audio system.

The basic principle of the present invention is to convey a flow of electrons transmitting an audio signal in a conductor into a magnetic field that varies according to said audio signal. Said magnetic field is made as strong as possible by preferably utilizing ferromagnetic material or a coil. In the preferred embodiment presented in FIG. 1, said magnetic field is created by means of a coil 12. FIG. 1 presents a cross-section of a wound coil 12, which is comprised of a metal core 10, preferably made of soft iron, a coil body surrounding the metal core, cross-sectional drawing references 11a and 11b, preferably made of an insulating material such as plastic or cardboard, and a conductor winding, whose first end 13a is at the innermost layer of the winding 12 against the coil body and whose second end 13b is at the outermost layer of the winding 12. The coil core 10 is preferably round in shape, whereupon the coil wound around it is also preferably round in shape. The material of the coil conductor is metal, preferably one of the following: copper, aluminum, iron, nickel, cobalt or a mixture of these, and more preferably ferromagnetic metal, such as iron, nickel or cobalt or a combination containing one of these.

One device implemented according to the structural principle shown in FIG. 1, which improves the reproduction of an audio signal according to the present invention, has the following mechanical structure and dimensions. The coil core 10 is made of iron, and its length is 50 mm and diameter is 6 mm. The coil core is covered by a coil body, cross-sectional drawing references 11a, 11b, made of nylon (PA). The actual winding 12 is wound from iron wire with a diameter of ˜1 mm. The number of turns of wire in the coil 12 is preferably ˜200. The selected design creates a strong magnetic field in the coil.

Certain types of speakers require a stronger magnetic field to produce a synchronization phenomenon. This is possible by advantageously utilizing an exemplary design presented in FIG. 2. In said design the iron core 20 of a device according to the present invention forms two closed magnetic fields 20a and 20b. Also in this embodiment coil 22 is preferably wound around a separate coil body, cross-sectional drawing references 21a and 21b. The conductor winding is wound so that the first end 23a of the conductor winding is at the innermost layer of the winding 22 against the coil body and the second end 23b is at the outermost layer of the winding 22. Closed magnetic circuits 20a, 20b strengthen the magnetic field produced by the formed coil 22. If iron wire is used as the coil wire, the effective size of the iron core is increased.

FIG. 3 presents a third exemplary preferred embodiment of the present invention. In the embodiment presented in FIG. 3, the signal conductor of an audio cable is wound around an iron core 30. A signal enters a coil 32 according to the present invention at its first end 33a and leaves at its second end 33b. The coil 32 formed by the conductor may be comprised of one or several turn(s) around the iron core 30.

FIG. 4a shows an exemplary presentation of how means according to the present invention, which belong to a device arrangement according to the present invention, are connected to audio cabling. A signal is fed from the positive output of an audio amplifier 41 into a conductor 43 of an audio cable. Means according to the present invention, which in the exemplary embodiment shown in FIG. 4a is a coil 42a, are connected in series with the signal conductor 43. The signal conductor 43 coming from an audio amplifier is connected to the first end of coil 42a. Coil 42a is preferably implemented according to one of the designs presented in FIG. 1, 2 or 3. If the device is implemented according to a structure presented in FIG. 3, then the positive signal conductor 43 of the audio cable is wound around a soft-iron core. A ground conductor or return conductor 45 of the audio cable is not connected to the means according to the present invention. The signal conductor is connected from the second end of the coil 42a to a speaker element 44 according to the prior art.

A device arrangement according to FIG. 2 may create too great an inductance in the coil 22. The inductance can be reduced using a method according to FIG. 4b, where the overall coil 42 is comprised of two coils wound in opposite directions, first coil 42b and second coil 42c, which method reduces the inductance of the overall coil 42 to a desired level. Both coils 42b and 42c are preferably wound around the same coil core. In the embodiment presented in FIG. 4b a signal conductor 43 is connected to the positive output of an audio amplifier 41. The second end of the signal conductor 43 is connected to the first end of the first coil 42b according to the present invention. After the second end of the first coil 42b there is a branch point 46, from which a first conductor branch is connected to a speaker element 44 and a second conductor branch is connected to the first end of the second coil 42c. A conductor branch leaving the second end of the second coil 42c is connected to a return/ground conductor. The direction of winding of the second coil 42c is preferably opposite to the direction of winding of the first coil 42b. Furthermore, the ratio of windings of the first coil 42b and the second coil 42c should be kept small, preferably in the magnitude of 1:1 to 1:3.

In a fourth preferred embodiment presented in FIGS. 5a and 5b, said magnetic field is created by means of a component wound with a ferromagnetic metal wire, such as iron. FIG. 5a presents a cross-section of the wound component 56, which is comprised of an air-core body 54, preferably made of an insulating material such as plastic or cardboard, and a conductor winding 53, preferably made of non-insulated iron wire with a cleaned surface. The conductor winding 53 is preferably comprised of two intertwined cleaned strands of iron wire 51 and 52. The first end 55a of the conductor is at the innermost layer of the winding 53 against the coil body and the second end 55b of the conductor is at the outermost layer of the winding. The coil body 54 is preferably round in shape, whereupon the coil wound around it is also preferably round in shape. FIG. 5b presents a side view of the wound component 56.

One device implemented according to the structural principle shown in FIG. 5b, which improves the reproduction of an audio signal according to the present invention, has the following mechanical structure and dimensions. The coil body 54 is made of plastic, and its length is 200 mm and diameter is 20 mm. The actual winding is made of clean-ground iron wire with a diameter of ˜0.9 mm, two strands of which are first intertwined. The resulting double spiral structure is wound around the coil body. A total of 200 g of iron wire is used in the implementation. The resistance of the winding is less than 1 Ω. The thickness of the iron wire is significant, and the 0.9 mm wire used is observed to be preferred. Furthermore, the coil is treated with alternating current (current ˜3-5 A, current ˜20 Hz) for a few hours, whereupon the effect on the sound reproduction of a device according to the present invention begins immediately upon installation. Otherwise, the arrangement requires a period of normal use before good sound reproduction is achieved.

In one preferred embodiment, pretreatment is performed in several phases: first the coil is treated with alternating current (current ˜3-5 A, current frequency ˜20 Hz) for an hour while the coil is heated by means of external radiated heat to a temperature of ˜300-400° C., then the alternating current treatment is continued without heating for an hour, and finally the alternating current treatment is continued for an hour while gradually decreasing the current to 0 A.

FIG. 6 shows an exemplary presentation of a fifth preferred embodiment of the present invention. In the embodiment presented in FIG. 6, iron powder 62 is packed into a housing 60. The housing has two ends: a first end 64 and a second end 65. An input conductor 61 is connected to the first end 64 of the housing and an output conductor 63 is connected to the second end 65 of the housing for an audio signal. The conductors are in electrical contact with the iron powder 62 in the housing by means of electrodes 66 and 67. A signal enters the device 68 according to the present invention at its first end 64 through conductor 61 and exits from the second end 65 of the device through conductor 63.

FIG. 7 presents an exemplary diagram of a sixth preferred embodiment of the present invention. An input conductor 61 and an output conductor 63 are connected to an intermediate component 72 made of ferromagnetic material and the intermediate component is heated by means of external energy 74 by conducting energy from an external energy source 70 into the intermediate component 72. In one exemplary embodiment the intermediate component is heated by means of external heat radiation to a temperature of ˜500-700° C. during use.

FIG. 8 shows an exemplary presentation of how means according to the present invention, which belong to a device arrangement according to the present invention, are connected to audio cabling. A signal is fed from the positive output of an audio amplifier 80 into a conductor 81 of an audio cable. Means 82 according to the present invention, which in the exemplary embodiment shown in FIG. 8 may be a coil made of iron wire or a housing containing iron powder, are connected in series with the signal conductor 81. A coil is preferably implemented according to the structure presented in FIG. 5 and means containing iron powder are preferably implemented according to the structure presented in FIG. 6. When using external energy, an arrangement presented in FIG. 7 is used to heat the means 82. A ground conductor or return conductor 84 of the audio cable is not connected to the means according to the present invention. A signal conductor is preferably connected from the second end of the means 82 to a speaker element 83 according to the prior art.

Certain preferred embodiments according to the present invention are described above. The inventive idea may be applied in numerous ways to the extent allowed by the enclosed claims.

1. A method for improving the quality of an audible audio signal, in which method an audio signal is transmitted from an audio amplifier (41, 80) to a speaker by means of electron movement in a metal conductor, wherein before said signal is conducted to said speaker, the audio signal is conducted into a coil or an intermediate component made of ferromagnetic material, in which intermediate component said audio signal creates a magnetic field, which improves the quality of the audio signal.

2. A device for improving the sound reproduction of an audio signal, which device is arranged to be connected between an audio amplifier and a speaker element wherein said device also comprises means for creating a magnetic field according to said audio signal to improve the quality of the audio signal.

3. The device according to claim 2, wherein the means for creating a magnetic field comprises a coil through which a the audio signal is arranged to travel in order to create a magnetic field that varies according to said audio signal.

4. (canceled)

5. The device according to claim 3, wherein the means for creating a magnetic field also comprises a second coil for regulating the overall inductance of said device to a desired level.

6. The device according to claim 5, wherein the direction of winding of said second coil is opposite the direction of winding of the first coil.

7. The device according to claim 6, wherein the winding ratio of the first coil and the second coil is in the magnitude of 1:1 to 1:3.

8. The device according to claim 7, wherein the first coil and the second coil are wound around the same coil core.

9. The device according to claim 2, wherein the means for creating a magnetic field comprises an intermediate component made of ferromagnetic metal, through which the audio signal is arranged to travel in order to create a magnetic field that varies according to said audio signal.

10. (canceled)

11. The device arrangement according to claim 9, wherein the intermediate component made of ferromagnetic metal comprises an entity wound from a ferromagnetic metal conductor.

12. The device according to claim 11, wherein the intermediate component made of ferromagnetic metal comprises an entity of ferromagnetic metal conductor in electrical contact with itself in several places.

13. The device according to claim 11, wherein the diameter of the metal conductor used is ˜0.9 mm.

14. The device according to claim 9, wherein the intermediate component made of ferromagnetic metal comprises housed ferromagnetic metal powder.

15. The device according to claim 9, wherein the intermediate component made of ferromagnetic metal is arranged to be heated by means of external energy.

16. The device according to claim 15, wherein the temperature of the intermediate component is ˜500-700° C.

17. The device according to claim 10, wherein the ferromagnetic metal used is iron, nickel or cobalt, or a combination containing one of these.

18. The device arrangement according to claim 11, wherein the intermediate component made of ferromagnetic metal is arranged to be pretreated with alternating current in the magnitude of 20 Hz and 3-5 A before actual use.

19. The device according to claim 18, wherein the intermediate component is arranged to be pretreated in three phases: first an alternating current treatment is arranged to treat the intermediate component with alternating current in the magnitude of 20 Hz and 3-5 A while the temperature of the intermediate component is arranged to be in the magnitude of 300-400° C. by means of external energy, then a similar alternating current treatment is arranged without heating and finally the current is arranged to gradually decrease to 0 A.

20. The device arrangement according to claim 19, wherein each phase of pretreatment lasts approximately one hour.
